(19) United States
(12) Patent Application Publication
(10) Pub. No.: US 2026/0166968 A1
(43) Pub. Date: Jun. 18, 2026

(54) Air Conditioner and Motor Vehicle with Such an Air Conditioner

(71) Applicant: MAHLE International GmbH, Stuttgart (DE)

(72) Inventors: Kerstin Wochele, Friolzheim (DE); Lukas Pobitzer, Weinstadt (DE); Matthias Schall, Ostfildern-Ruit (DE)

(21) Appl. No.: 19/416,743

(22) Filed: Dec. 11, 2025

(30) Foreign Application Priority Data
Dec. 13, 2024 (DE) 102024137688.0

(51) Int. Cl. B60H 3/02; F24F 3/14

(52) U.S. Cl. CPC B60H 3/024; F24F 3/1411; F24F 2003/144

(57) ABSTRACT

An air conditioner for a motor vehicle that has a dehumidifier in or on a flow channel is provided. The Air conditioner contains a first semicylindrical hygroscopic element that can be heated, and a second semicylindrical hygroscopic element that can be heated, wherein
the flow channel is divided into two sub-channels downstream of the dehumidifier,
the two elements can be moved by an adjuster, in particular a rotator, and the element aligned with the second sub-channel is then heated and thus switched to a desorption state.

### CROSS-REFERENCE TO RELATED APPLICATIONS

This application claims priority from German Patent Application No. DE 102024137688.0, filed on Dec. 13, 2024, the entirety of which is hereby incorporated by reference herein.

The present invention relates to an air conditioner for a motor vehicle. The invention also relates to a motor vehicle that has such an air conditioner.

Particularly for electric vehicles, a very efficient air conditioner is needed to avoid unnecessarily limiting their travel range. To be able to reduce the amount of energy used for heating the vehicle in winter, the aim is to make maximum use of air that has already been heated. People or other objects contribute significantly to the humidity in the air circulating in a passenger compartment. When it is cold outside, particularly in winter, this contributes substantially the amount of condensation that may accumulate on the windows. For this reason, a significantly higher portion of fresh air has been used in the prior art to prevent this.

The disadvantage with this is that it consumes more electricity, because this fresh air must first be heated, in particular when it is cold outside.

The problem addressed by the present invention is to create an air conditioner for a motor vehicle with which the problems from the prior art can be overcome.

This problem is solved with the invention by the subject matter of the independent Numbered Paragraph 1. Advantageous embodiments are the subject matter of the dependent Numbered Paragraphs.

The present invention is based on the concept of creating an efficient means of air conditioning a motor vehicle, e.g. an electric vehicle, even when it is cold outside, with which it is possible to operate the air conditioner as long as possible in the recirculating mode by using a dehumidifier, which adsorbs the humidity generated by people in the passenger compartment and discharges it into the environment. The air conditioner for a vehicle obtained with the invention therefore has such a dehumidifier in an airflow channel that has a first hygroscopic semicylindrical element that can be heated, in particular a PTC element, and a second hygroscopic semicylindrical element that can be heated, in particular a PTC element. The elements are heated with electricity. The airflow channel divides into two sub-channels downstream of the airflow channel. There is also a rotating or translatory adjuster with which the elements can be rotated or moved, and the element that is aligned with the second sub-channel is switched to a desorption state when it is heated. This makes it possible with the air conditioner obtained with the invention to heat a part of the element that is to be dried and to align with the second sub-channel, which leads to the exterior. Consequently, the air conditioner can be operated most of the time in the recirculating mode, such that the air from the passenger compartment is dehumidified by the air conditioner and the element aligned with the first sub-channel, which is not supplied with electricity, and returned to the passenger compartment. Because it is hygroscopic, in particular with a hygroscopic coating or a hygroscopic material in the element, the dehumidifier, or its element, adsorbs moisture from the air that is sent or returned to the passenger compartment. When the hygroscopic coating or material can no longer accommodate any moisture, e.g. after a specific period of time, which can also be detected by a moisture sensor, the adjuster moves the first element from the first sub-channel to the second, and the second element from the second sub-channel to the first. At this point, the first element is supplied with electricity and heated, such that it discharges moisture into the sub-channel leading to the exterior, while the electricity to the second element, which is dry, is switched off, such that it can adsorb moisture. This dehumidifier makes it possible, in a structurally simple manner, to dehumidify the airflow through the air conditioner, such that it can be operated in an energy-saving recirculating mode over long periods of time in the winter. This recirculating mode has the major advantage, specifically in winter, that less fresh air has to be supplied to the passenger compartment, which would also have to be heated. These elements, with the adjuster, can also be produced inexpensively and easily, resulting in an inexpensive but extremely effective air conditioner with regard to conserving energy. Particularly with electric vehicles, air conditioners consume a lot of energy, such that an air conditioner that uses less electricity if of particular significance. By switching between the adsorption state and desorption state, dehumidified air can be supplied over a long period of time to the passenger compartment, regardless of the people and/or objects that contribute to the condensation therein.

In an advantageous design of the air conditioner obtained with the invention, the first sub-channel opens into the passenger compartment, and the second sub-channel opens into the exterior. Consequently, dehumidified air can be supplied constantly to the passenger compartment with the air conditioner obtained with the invention. When the air in the passenger compartment is sufficiently dry, the hygroscopic elements are no longer moved, such that after the hygroscopic element is saturated, it no longer adsorbs any moisture.

The dehumidifier in the air conditioner obtained with the invention can be downstream or upstream of a fan and a filter. This results in a split construction in which the dehumidifier and fan are outside the passenger compartment, and the filter is inside the passenger compartment. This structure can take specific installation spaces into account in the vehicle. The dehumidifier can also be placed downstream of the fan as well as the filter, such that the fan is between the dehumidifier and the filter. This can also result in a split construction. This can free up installation space in the dashboard that can then be populated with other components such as display elements.

There can also be two dehumidifiers and two first and second sub-channels. In this case, the two first sub-channels and dehumidifiers lead to the passenger compartment, and the two second sub-channels lead to the exterior, i.e. the environment. With two dehumidifiers, a redundant system is obtained which can be operated for a long time in the recirculation mode, even in winter, and even if one of the dehumidifiers fails. If, for example, there is a lot of humidity in the passenger compartment, the two dehumidifiers can reduce the condensation level more quickly. The first dehumidifier can also function as the primary component, and the second as a secondary component, which is only activated when necessary.

There can also be a control unit in the air conditioner that is connected to the at least one dehumidifier and the adjuster, which supplies electricity to the element in the dehumidifier that is aligned with the second sub-channel, thus heating it and switching it to the desorption state. This element is only supplied electricity, and therefore heated, when it is aligned with the second sub-channel, in order to discharge moisture from the hygroscopic element. The first element, which is aligned with the first sub-channel, is not supplied with electricity, and therefore not heated, and can therefore adsorb moisture until it is saturated.

There is a secondary fan in the second sub-channel. This secondary fan, which accelerates the removal of moisture when the dehumidifier is in the desorption state, i.e. when the element is heated, can be smaller than the primary fan.

The present invention is also based on the general idea of creating a motor vehicle that has a passenger compartment and the air conditioner described above, which has the same advantages as those attributed to the air conditioner. These advantages include an effective and energy-efficient dehumidifying of an air flow with the dehumidifier and the moving elements therein, such that the passenger compartment can be heated in the recirculating mode, in particular in winter, in an extremely energy-efficient manner. Particular in cold conditions, excessive humidity in the passenger compartment can result in condensation accumulating on the windows, which can obscure vision and result in long-term damage. This can be effectively and inexpensively prevented with the vehicle obtained with the invention.

This vehicle is ideally an electric vehicle. It can also be a hybrid vehicle. In either case, the air conditioner obtained with the invention can be operated in the recirculating mode for long periods of time, even in winter, thus conserving electricity, because air recirculating through the air conditioner in this mode does not have to be heated as much as fresh air. This requires less electricity, thus increasing the travel range of an electric or hybrid vehicle.

Other important features and advantages of the invention can be derived from the dependent Numbered Paragraphs, drawings, and descriptions of the drawings.

It is understood that the features specified above and explained below can be used not only in the given combinations, but also in other combinations or in and of themselves, without abandoning the scope of protection for the invention. Components of a higher-order unit, device or system that are referred to separately can be separate components of this unit or integral parts or sections thereof, even if otherwise indicated in the drawings.

Preferred exemplary embodiments of the invention are shown in the drawings and shall be explained in greater detail below, in which the same reference symbols are used for identical, similar, or functionally identical components.

Therein, schematically,

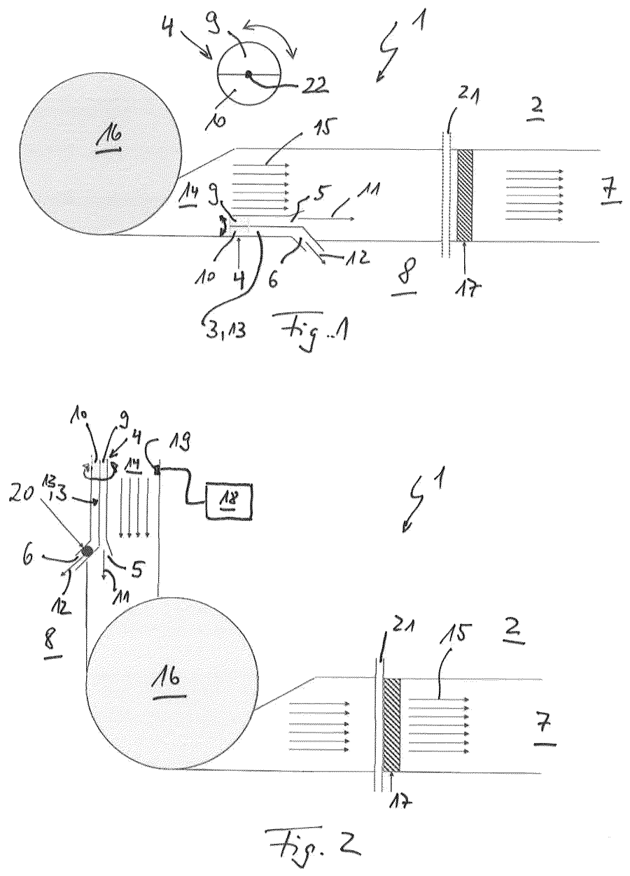

FIG. 1 shows a sectional view of a first embodiment of the air conditioner obtained with the invention, for a motor vehicle obtained with the invention,

FIG. 2 shows the same as that in FIG. 1, but with the dehumidifier upstream of the fan,

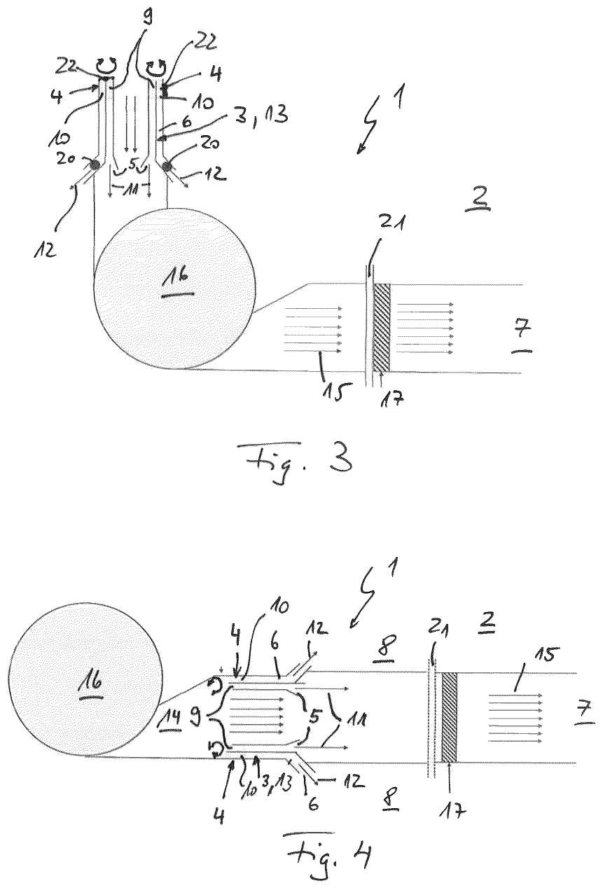

FIG. 3 shows the same as that in FIG. 2, but with two dehumidifiers,

FIG. 4 shows the same as that in FIG. 1, but also with two dehumidifiers.

The air conditioner 1 obtained with the invention shown in FIGS. 1-4, for an otherwise not shown motor vehicle 2, has a dehumidifier 4 in or on an airflow channel 3, which has a first ceramic, semicylindrical and hygroscopic element 9 that can be heated, which has a hygroscopic coating, and a second ceramic, semicylindrical and hygroscopic element 10 that can be heated. These elements 9, 10, in particular PTC elements, can thus be used as heating elements, which can adsorb moisture when they are not heated, such that water is adsorbed in a hygroscopic coating on the element 9, 10, and when they are heated, their hygroscopic coating is switched to a desorption state, such that moisture is discharged from the hygroscopic coating.

These elements 9, 10 can also be PTC elements with a semi-annular or similar design.

The airflow channel 3 divides downstream of the dehumidifier 4 into two sub-channels 5, 6, specifically a first sub-channel 5, which leads to a passenger compartment 7, and a second sub-channel 6, which leads to the exterior of the vehicle. There is also an adjuster 22, in particular a rotator, which can move the two elements 9, 10, in particular by rotating them, such that the element 9, 10 that is aligned with the second sub-channel 6 is supplied with electricity, and therefore heated, thus switching it to the desorption state.

It is understood that the element 9, 10 that is aligned with the second sub-channel 6 can be supplied with electricity and thus heated and dried, but this is not necessary.

The two semicylindrical elements 9, 10 can be combined to form a cylindrical element that can be rotated by the adjuster 22. If the adjuster 22 is a rotator, its axis of rotation is coaxial to the cylinder axis. The first and second sub-channels 5, 6 have semicircular cross sections that are complementary to the semicircular cross sections of the elements 9, 10. The sub-channels 5, 6 are thus combined to form a circular cross section, just like that of the two semicylindrical elements 9, 10.

FIGS. 1 to 4 also show that the airflow channel 3, in or on which the dehumidifier 4 is located, also forms a secondary channel 13, which has a significantly smaller cross section than the main channel 14, and is parallel thereto, in which air flows into the passenger compartment 7.

As shown in FIG. 1, as well as in FIG. 4, the dehumidifier 4 is downstream of a fan 16 and upstream of a filter 17. The dehumidifier 4 and the elements 9, 10 can also be downstream of the fan 16 and the filter 17, as shown in FIGS. 2 and 3. These different possible positions of the dehumidifier 4 with the elements 9, 10, and the two sub-channels 5, 6, can be determined by the specific installation spaces, or can take these individual installation spaces into account. The fan 16 can be a radial fan.

In the embodiment shown in FIGS. 1 and 2, the air conditioner 1 has only one dehumidifier 4, two elements 9, 10, one first sub-channel 5, and one second sub-channel 6. In the embodiment shown in FIGS. 3 and 4, there are two dehumidifiers 4, two first sub-channels 5, and two second sub-channels 6. The embodiment shown in FIGS. 3 and 4 thus forms a redundant system, which is extremely effective when both dehumidifiers 4 are functioning, and still effectively dehumidifies the air recirculating to the passenger compartment 7 when one of the dehumidifiers fails. The use of two such dehumidifiers 4, which each have two elements 9, 10, and two first and second sub-channels 5, 6 has the major advantage that the air sent or returned to the passenger compartment 7 is more quickly dehumidified when there is a great deal of moisture therein, such that the recirculation mode can still be used, even if it is very humid in the passenger compartment 7. One of the dehumidifiers 4 can be the primary dehumidifier, and the other can be used only when the humidity reaches peak levels.

In FIG. 1, the fan 16, dehumidifier 4, the elements 9, 10, and both sub-channels 5, 6 are in front of a separating wall 21, which can be between the passenger compartment 7 and a space that is in front of it in the direction of travel. In this case, the fan 16, dehumidifier 4, the elements 9, 10, and both sub-channels 5, 6 are on one side of the wall 21, and the filter element 17 is on the other side, i.e. in the passenger compartment 7, for example. This allows for an effective split construction. The air conditioner 1 in FIG. 4 has a similar construction, but with two dehumidifiers 4, which each have two elements 9, 10, and two first and second sub-channels 5, 6.

The air sent to the passenger compartment 7 can be filtered by the filter 17 shown in FIGS. 1-4 . This can be a particle filter or a virus filter made of activated carbon, with which hydrocarbons can be filtered out, for example.

Both the first airflow 11, into the passenger compartment 7, and the second airflow 12, into the exterior 8, are indicated in FIGS. 2 to 4, by means of which the major advantage of the invention is obtained, in that the first element 9, which is aligned with the first sub-channel 5 and not supplied with electricity, can be operated in the adsorption state, while the heated second element 10, which is aligned with the second sub-channel 6, can be in the desorption state. After rotating 180°, the second element 10, which is then dry and no longer supplied with electricity, can dehumidify the airflow 11 into the passenger compartment 7, while the first element 9 is aligned with the second sub-channel 6, and heated, and can thus be dried.

The section of the channel containing the dehumidifier 4, shutter assembly 9, and both sub-channels 5, 6 in the embodiment shown in FIGS. 2 and 3 is orthogonal to a channel section leading to the passenger compartment 7, such that the specifics of the installation space can be taken into account.

There can also be a control unit 18, which is only shown in FIG. 2 for purposes of clarity, which is connected to the at least one dehumidifier 4 and the adjuster 22. This control unit 18 heats the element 9, 10 in the dehumidifier 4 that is aligned with the second sub-channel 6, such that its hygroscopic material, or hygroscopic coating, is switched to the desorption state, conducting moisture with the second air flow 12 out of the vehicle 2 into the exterior 8. Activating the adjuster 22, or providing electricity to the dehumidifier 4, or the elements 9, 10 therein, depends on the humidity level, which can be detected by a moisture sensor 19, which is also connected to the control unit 18. In this case, the element 9, 10 aligned with the second sub-channel is supplied with electricity and therefore heated if the sensor 19 detects that a predefined humidity level has been reached or exceeded. Consequently, the dehumidifier 4 and a first airflow 11 into or returned to the passenger compartment 7 can be controlled automatically, resulting in significantly better air conditioning.

FIGS. 1 to 4 also show that the secondary channel 13, containing the dehumidifier 4, has a much smaller cross section than the main channel 14, which has the major advantage that in the normal operating mode, in which it is unnecessary to dehumidify the air recirculated to the passenger compartment 7, a larger cross section is available, which generates less noise. If the moisture sensor 19 detects excessive humidity, the control unit 18 supplies electricity to the element 9, 10 that is aligned with the second sub-channel 6, heating it such that it is in the desorption state, i.e. such that it discharges moisture. This only requires the smaller cross section of the airflow channel 3, or the secondary channel 13, and the second sub-channel 6.

To further dehumidify the air flowing through the dehumidifier 4, there can also be a secondary fan 20 in the second sub-channel 6, and if there are two second sub-channels 6, as is the case in FIGS. 3 and 4, there can also be two secondary fans 20.

It is possible to air condition a vehicle 2, which can be an electric vehicle or hybrid vehicle, with the air conditioner 1 obtained with the invention for a longer period of time in the energy-saving recirculation mode, in particular in winter, such that fresh air does not need to be obtained from the exterior, which must then be heated.

The specification can be readily understood with reference to the following Numbered Paragraphs:
Numbered Paragraph 1. An air conditioner (1) for a motor vehicle (2) that has a dehumidifier (4) in or on a flow channel (3), which contains a first semicylindrical hygroscopic element (9) that can be heated, and a second semicylindrical hygroscopic element (10) that can be heated, wherein
   the flow channel (3) is divided into two sub-channels (5, 6) downstream of the dehumidifier (4),
   the two elements (9, 10) can be moved by an adjuster, in particular a rotator, and the element (9, 10) aligned with the second sub-channel (6) is then heated and thus switched to a desorption state.
Numbered Paragraph 2. The air conditioner (1) according to Numbered Paragraph 1, characterized in that the first sub-channel (5) opens into a passenger compartment (7), and the second sub-channel (6) opens into the exterior (8).
Numbered Paragraph 3. The air conditioner (1) according to Numbered Paragraph 1 or 2, characterized in that the dehumidifier (4) is downstream or upstream of a fan (16).
Numbered Paragraph 4. The air conditioner (1) according to Numbered Paragraph 1 or 2, characterized in that the dehumidifier (4) is upstream of a fan (16) and upstream of a filter (17).
Numbered Paragraph 5. The air conditioner (1) according to any of the preceding Numbered Paragraphs, characterized in that there are two dehumidifiers (4) and two first and second sub-channels (5, 6).
Numbered Paragraph 6. The air conditioner (1) according to any of the preceding Numbered Paragraphs, characterized in that there is a control unit (18) connected to the at least one dehumidifier (4) and the rotator (22).
Numbered Paragraph 7. The air conditioner (1) according to Numbered Paragraph 6, characterized in that the control unit (18) only heats the element (9, 10) in the dehumidifier (4), thus switching it to the desorption state, that is aligned with the second sub-channel (6).
Numbered Paragraph 8. The air conditioner (1) according to any of the preceding Numbered Paragraphs, characterized in that there is a secondary fan (20) in the second sub-channel (6).
Numbered Paragraph 9. A motor vehicle (2) that has a passenger compartment (7) and an air conditioner (1) according to any of the preceding Numbered Paragraphs.
Numbered Paragraph 10. The motor vehicle according to Numbered Paragraph 9, characterized in that the motor vehicle (2) is an electric vehicle.

### LIST OF REFERENCE SYMBOLS

1 air conditioner
2 motor vehicle
3 flow channel
4 dehumidifier
5 first sub-channel
6 second sub-channel
7 passenger compartment
8 exterior/environment
9 first hygroscopic element
10 second hygroscopic element
11 airflow in first sub-channel
12 airflow in second sub-channel
13 secondary channel
14 main channel
15 flow direction
16 fan
17 filter
18 control unit
19 humidity sensor
20 secondary fan
21 separating wall
22 adjuster/rotator

1-10. (canceled)

11. An air conditioner for a vehicle, comprising: a dehumidifier in or on a flow channel, the dehumidifier comprises a first semicylindrical hygroscopic element that is configured to be heated, and a second semicylindrical hygroscopic element that is configured to be heated, wherein
the flow channel is divided into a first sub-channel and a second sub-channel downstream of the dehumidifier,
the first and second hygroscopic elements are each configured to be moved by a rotator, wherein after at least one of the first and second hygroscopic elements is moved, the hygroscopic element that is aligned with the second sub-channel is heated and thus switched to a desorption state.

12. The air conditioner according to claim 11, wherein the first sub-channel (5) opens into a passenger compartment, and the second sub-channel opens into an exterior of a vehicle that includes the passenger compartment.

13. The air conditioner according to claim 11, wherein the dehumidifier is disposed either downstream or upstream of a fan.

14. The air conditioner according to claim 11, wherein the dehumidifier is disposed upstream of a fan and upstream of a filter.

15. The air conditioner according to claim 11, wherein the dehumidifier is first and second dehumidifiers that each include first and second sub-channels.

16. The air conditioner according to claim 11, further comprising a control unit connected to the at least one dehumidifier and the rotator.

17. The air conditioner according to claim 16, wherein the control unit is configured to only heat the respective hygroscopic element in the dehumidifier that is aligned with the second sub-channel, thus switching the heated hygroscopic element to the desorption state.

18. The air conditioner according to claim 11, further comprising a secondary fan in the second sub-channel.

19. A motor vehicle that comprises a passenger compartment and an air conditioner according to claim 11.

20. The motor vehicle according to claim 19, wherein the motor vehicle is an electric vehicle.
